(19) United States
(12) Patent Application Publication
(10) Pub. No.: US 2026/0140302 A1
(43) Pub. Date: May 21, 2026

(54) HOLLOW CORE OPTICAL FIBRE TRANSMISSION LINK

(71) Applicant: Microsoft Technology Licensing, LLC, Redmond, WA (US)

(72) Inventors: Andrew Thomas HARKER, Romsey (GB); Ian Dewi LANG, Romsey (GB)

(73) Assignee: Microsoft Technology Licensing, LLC, Redmond, WA (US)

(21) Appl. No.: 19/120,048

(22) PCT Filed: Sep. 1, 2023
(86) PCT No.: PCT/US2023/031801

§ 371 Date: Apr. 10, 2025

(30) Foreign Application Priority Data
Oct. 12, 2022 (GB) 2215027.0

(51) Int. Cl. G02B 6/02; G02B 6/12; G02B 6/255

(52) U.S. Cl. CPC G02B 6/02328; G02B 6/12; G02B 6/255; G02B 2006/12192

(57) ABSTRACT

An optical fibre transmission link for propagating optical signals at a selected wavelength or wavelength range to and/or from a transceiver comprises: portions of optical fibre arranged sequentially along a length of the optical fibre transmission link, the portions of optical fibre comprising at least two portions of hollow core optical fibre, the at least two portions of hollow core optical fibre including at least one short portion of hollow core optical fibre having a length of 100 m or less and at least one long portion of hollow core optical fibre having a length of 500 m or more; wherein the at least one short portion has a higher order mode attenuation at the wavelength or wavelength range which is greater than a higher order mode attenuation at the wavelength or wavelength range of the at least one long portion.

### BACKGROUND OF THE INVENTION

The present invention relates to hollow core optical fibre transmission links and methods for forming hollow core optical fibre transmission links.

An important use of optical fibres is for the transmission of data, such as in telecommunications applications. Typically, the data are encoded in optical signals which are carried between transceivers (where a transceiver may be an apparatus configured to transmit, to receive, or both transmit and receive) located at remotely spaced datacentres by transmission links formed from optical fibres. Other arrangements, such as signal propagation in a 5G network, can also utilise optical fibres to transmit optical signals between transceivers at remotely spaced locations. Conventionally, optical fibres having a solid waveguiding core configured for the propagation of a single optical mode (single mode fibre) or multiple optical modes (multimode fibre) have been used. A widely-used example is single mode silica optical fibre carrying optical signals at a wavelength of about 1550 nm, where silica has its lowest loss so that signals can be propagated over long distances with the minimum attenuation. Optical fibres for carrying data signals can be packaged into cables including one or more fibres within an outer jacket that protects the fibres during deployment and use of the fibres.

The growth of global data traffic has brought the fundamental limits of these conventional fibres in sight, however. Data transmission appetites of emerging technologies such as large-scale datacentres and 5G networks and demands for precision in optical fibre applications such as sensing, metrology and timing synchronisation are creating a requirement for a new generation of optical fibres with superior performance. Hollow core optical fibres are an attractive option for meeting many of these needs.

Hollow core fibres provide an alternative to conventional solid core fibres by guiding light in air instead of glass. This enables data transmission at near-vacuum light speeds, at higher optical powers and over broader optical bandwidths, with relative freedom from issues such as nonlinear and thermo-optic effects that can affect optical waves travelling in solid material. Hollow core fibres can be packaged into cable formats deployable for optical data transmission, and are hence usable for optical fibre transmission links in the same way as conventional fibres. Many types of optical fibres, including hollow core fibres, can suffer from an impairment to optimum transmission performance known as multipath interference (MPI) or intermodal interference (IMI), which can arise when an optical fibre can support and propagate, at the intended operating wavelength or wavelength band, at least one higher order optical mode in addition to the desired fundamental optical mode by which light propagates along the core of the fibre. A transmission link typically includes multiple joins, comprising connectors or splices, between successive lengths of optical fibre (so as to include different types of fibre, to connect between various components (such as patch panels) in a datacentre, or other optical signal handling facility, to accommodate components such as amplifiers along the span of the link, and to achieve the required total link length), and these joins may cause the propagating optical power to couple from the fundamental mode into higher order modes and back again. This creates multiple replicas of the original optical signal that follow different propagation paths and hence become delayed relative to one another and the fundamental mode, and therefore interfere with the fundamental mode at the destination receiver; this is the multipath interference. This leads to a rapid deterioration of the performance of an optical communication system after the total optical power in the higher order modes exceeds a certain threshold [1]. The mode coupling described above is known as discrete mode coupling because it occurs at discrete locations along the transmission link, for example at connectors and splices. Continuous mode coupling is also possible; this arises from variations in optical properties along the fibre which may be intrinsic or introduced during manufacture of the fibre.

Hollow core optical fibres generally support a fundamental mode and at least one higher order optical mode [2]. Consequently, optical fibre transmission links utilising hollow core optical fibres, while providing many benefits over the use of solid core fibre, may be limited by multipath interference. Both the fundamental mode and the higher order modes experience optical propagation loss and hence become attenuated as they propagate along a fibre. The higher order modes attenuate considerably more rapidly than the fundamental modes. A possible solution to the problem of multipath interference is therefore to use a sufficiently long length of hollow core fibre between splices or connectors such that power coupled into higher order modes at a first join has at a next join attenuated to a level at which coupling back into the fundamental mode is below the threshold for multipath interference. However, this can be unsatisfactory since the extra length increases the overall propagation loss of the fundamental mode, and adds latency and cost to the transmission link.

Alternative approaches for mitigating the effect of multipath interference in hollow core optical fibre transmission links are therefore of interest.

### SUMMARY OF THE INVENTION

Aspects and embodiments are set out in the appended claims.

According to a first aspect of certain embodiments described herein, there is provided an optical fibre transmission link for propagating optical signals at a selected wavelength or wavelength range to and/or from an optical transceiver, the optical fibre transmission link comprising: portions of optical fibre arranged sequentially along a length of the optical fibre transmission link, the portions of optical fibre comprising at least two portions of hollow core optical fibre, the at least two portions of hollow core optical fibre including at least one short portion of hollow core optical fibre having a length of 100 m or less and at least one long portion of hollow core optical fibre having a length of 500 m or more; wherein the at least one short portion has a higher order mode attenuation at the wavelength or wavelength range which is greater than a higher order mode attenuation at the wavelength or wavelength range of the at least one long portion.

According to a second aspect of certain embodiments described herein, there is provided an optical fibre telecommunications system comprising a first and a second optical transceiver for transmitting and/or receiving optical signals, and an optical fibre transmission link according to the first aspect arranged to propagate optical signals between the first optical transceiver and the second optical transceiver.

According to a third aspect of certain embodiments described herein, there is provided a method for producing an optical fibre transmission link comprising: identifying a plurality of portions of optical fibre to be arranged sequentially to define an optical fibre transmission link for propagating optical signals at a selected wavelength or wavelength range to and/or from an optical transceiver; from the plurality of portions of optical fibre, identifying at least two portions to comprise portions of hollow core optical fibre, the at least two portions including at least one short portion of hollow core optical fibre having a length of 100 m or less and at least one long portion of hollow core optical fibre having a length of 500 m or more; selecting, for the at least one short portion, a hollow core optical fibre with a first higher order mode attenuation at the wavelength or wavelengths; and selecting, for the least one long portion, a hollow core optical fibre with a second higher order mode attenuation at the wavelength or wavelengths which is smaller than the first higher order mode attenuation.

These and further aspects of certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, methods and systems may be provided in accordance with approaches described herein which include any one or more of the various features described below as appropriate.

### BRIEF DESCRIPTION OF THE DRAWINGS

For a better understanding of the invention and to show how the same may be carried into effect reference is now made by way of example to the accompanying drawings in which:

FIG. 1 shows a simplified schematic transverse cross-sectional view of a first example hollow core optical fibre to which aspects of the invention are applicable;

FIG. 2 shows a simplified schematic transverse cross-sectional view of a second example hollow core optical fibre to which aspects of the invention are applicable;

FIG. 3 shows a simplified schematic transverse cross-sectional view of a third example hollow core optical fibre to which aspects of the invention are applicable;

FIG. 4 shows a simplified schematic representation of an example datacentre with an optical fibre transmission link which may be implemented according to embodiments of the invention;

FIG. 5 shows a simplified schematic representation of an example optical telecommunications system with an optical fibre transmissions link which may be implemented according to embodiments of the invention;

FIG. 6 shows a graph of the variation of differential optical propagation loss with hollow core optical fibre structure as defined by a geometric parameter;

FIG. 7 shows a simplified schematic representation of an example optical telecommunications system with a transmission link including hollow core optical fibre;

FIG. 8 shows the example telecommunications system of FIG. 7 in which the transmission link has been modified in accordance with embodiments of the invention; and

FIG. 9 shows a flow chart of steps in an example method according to embodiments of the invention.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of systems and methods discussed herein which are not described in detail may be implemented in accordance with any conventional techniques for implementing such aspects and features.

The present disclosure aims to address the deleterious effects of multipath interference on optical signal propagation in optical fibre transmission links comprising hollow core optical fibre.

Hollow core optical fibre has a core in which light is guided that comprises a central void (commonly filled with air, but also alternatively with another gas or mixture of gases, or a vacuum), surrounded by a cladding comprising a structured arrangement of longitudinal holes, voids or capillaries extending along the fibre length. The absence of a solid glass core reduces the proportion of a guided optical wave that propagates in glass compared to a solid core fibre, offering benefits such as increased propagation speed, reduced loss from both absorption and scattering, and reduced nonlinear interactions. As noted above, these properties make hollow core optical fibre very attractive for use in optical telecommunications systems.

Hollow core optical fibres can be categorised according to their mechanism of optical guidance into two principal classes or types: hollow core photonic bandgap fibre (HCPBF, alternatively often referred to as hollow core photonic crystal fibre, HCPCF), and antiresonant hollow core fibre (AR-HCF or ARF). There are various subcategories of ARFs characterised by their geometric structure, including kagome fibres, nested antiresonant nodeless fibres (NANFs) and tubular fibres. The present disclosure is applicable to all types of hollow core fibre, including these two main classes and their associated sub-types plus other hollow core designs. Note that in the art, there is some overlapping use of terminologies for the various classes of fibre. For the purposes of the present disclosure, the terms “hollow core optical fibre” and “hollow core fibre” are used interchangeably and intended to cover all types of these fibres having a hollow core as described above. The terms “HCPBF” and “HCPCF” are used to refer to hollow core fibres which have a structure that provides waveguiding by photonic bandgap effects (described in more detail below). The terms “ARF” and “antiresonant hollow core fibre” are used to refer to hollow core fibres which have a structure that provides waveguiding by antiresonant effects (also described in more detail below).

FIG. 1 shows a schematic transverse cross-sectional view of an example HCPBF 10. In this fibre type, a structured, inner, cladding 1 comprises a regular closely packed array of many small glass capillaries, from which a central group is excluded to define a substantially circular hollow core 2. The periodicity of the cladding structure provides a periodically structured refractive index and hence a photonic bandgap effect that confines the propagating optical wave towards the core. This is the fundamental optical mode or fundamental mode (FM). One or more higher order optical modes or higher order modes (HOMs), generally unwanted for telecommunications applications, may be supported in the core 2 and/or the cladding 1. These fibres can be described in terms of the number of cladding capillaries or “cells” which are excluded to make the core 2. In the FIG. 1 example, the central nineteen cells from the array are absent in the core region, making this a 19-cell core HCPBF. The structured cladding 1 is formed from six rings of cells surrounding the core 2, plus some cells in a seventh ring to improve the circularity of the outer surface of the cladding. An outer cladding or jacket 3 surrounds the structured cladding 1.

In contrast to HCPBF, antiresonant hollow core fibres guide light by an antiresonant optical guidance effect. The structured cladding of ARFs has a simpler configuration, comprising a much lower number of larger glass capillaries or tubes than a HCPBF, to give a structure lacking any high degree of periodicity so that photonic bandgap effects are not significant. Rather, antiresonance is provided for propagating wavelengths which are not resonant with a wall thickness of the cladding capillaries, in other words, for wavelengths in an antiresonance window which is defined by the cladding capillary wall thickness. The cladding capillaries surround a central void or cavity which provides the hollow core of the fibre, and which is able to support antiresonantly-guided optical modes, comprising the fundamental mode and one or more higher order modes. The structured cladding can also support cladding modes able to propagate primarily inside the capillaries, in the glass of the capillary walls or in the spaces or interstices between the cladding capillaries and the fibre's outer cladding. The loss of these additional higher order non-core guided modes is generally very much higher than that of the core guided modes. The fundamental core guided mode typically has by far the lowest loss amongst the core guided modes. The antiresonance provided by a capillary wall thickness which is in antiresonance with the wavelength of the propagating light acts to inhibit coupling between the fundamental core mode and any cladding modes, so that light is confined to the core and can propagate at very low loss. Nevertheless, higher order modes are supported, so that multipath interference can be a problem.

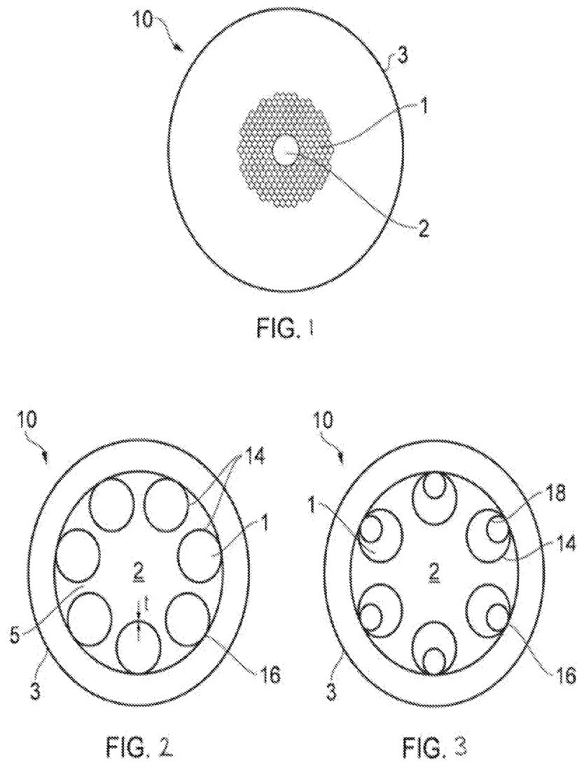

FIG. 2 shows a schematic transverse cross-sectional view of an example simple antiresonant hollow core fibre. The fibre 10 has an outer tubular cladding or jacket 3. A structured, inner, cladding 1 comprises a plurality of tubular cladding capillaries 14, in this example seven capillaries of the same cross-sectional size and shape, which are arranged inside the outer cladding 3 in a ring, so that the longitudinal axes of each cladding capillary 14 and of the outer cladding 3 are substantially parallel. Each cladding capillary 14 is in contact with (bonded to) the inner surface of the outer cladding 3 at an azimuthal location 16, such that the cladding capillaries 14 are evenly spaced around the inner circumference of the outer cladding 3, and are also spaced apart from each other by gaps 5 (there is no contact between neighbouring capillaries). In some designs of ARF, the cladding tubes 14 may be positioned in contact with each other (in other words, not spaced apart as in FIG. 2), but spacing to eliminate this contact can improve the fibre's optical performance. The spacing 5 removes nodes that arise at the contact points between adjacent tubes and which tend to cause undesirable resonances that result in high losses. Accordingly, fibres with spaced-apart cladding capillaries may be referred to as “nodeless antiresonant hollow core fibres”.

The arrangement of the cladding capillaries 14 in a ring around the inside of the tubular outer cladding 3 creates a central space, cavity or void within the fibre 10, also with its longitudinal axis parallel to those of the outer cladding 3 and the capillaries 14, which is the fibre's hollow core 2. The core 2 is bounded by the inwardly facing parts of the outer surfaces of the cladding capillaries 14. This is the core boundary, and the material (glass or polymer, for example) of the capillary walls that make up this boundary provides the required antiresonance optical guidance effect or mechanism. The capillaries 14 have a thickness t at the core boundary which defines the wavelength for which antiresonant optical guiding occurs in the ARF.

FIG. 2 shows merely one example of an ARF, and many other ARF structures are known.

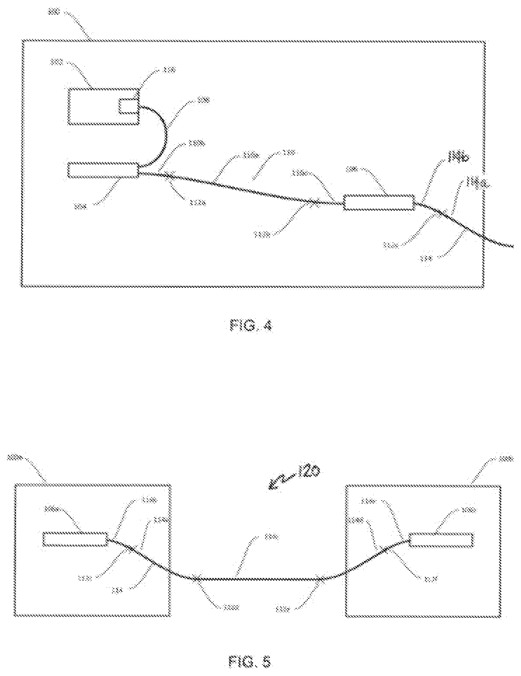

FIG. 3 shows a schematic transverse cross-sectional view of a second example ARF. The ARF has a structured inner cladding 1 comprising six cladding capillaries 14 evenly spaced apart around the inner surface of a tubular outer cladding 3 and surrounding a hollow core 2. Each cladding capillary 14 has a secondary, smaller capillary 18 nested inside it, bonded to the inner surface of the cladding capillary 14, in this example at the same azimuthal location 16 as the point of bonding between the primary capillary 14 and the outer cladding 3. These additional smaller capillaries 18 can reduce the optical loss. Additional still smaller tertiary capillaries may be nested inside the secondary capillaries 18. ARF designs of this type, with secondary and optionally smaller further capillaries, may be referred to as “nested antiresonant nodeless fibres”, or NANFs.

Many other capillary configurations for the structured cladding of an ARF are possible, and the disclosure is not limited to the examples described above. For example, the capillaries need not be of circular cross-section, and/or may or may not be all of the same size and/or shape. The number of capillaries surrounding the core may be for example, four, five, six, seven, eight, nine or ten, although other numbers are not excluded. The ring of cladding capillaries in an ARF creates a core boundary which has a shape comprising a series of adjacent inwardly curving surfaces (that is, convex from the point of view of the core). This contrasts with the usual outward curvature of the core-cladding interface in a conventional solid core fibre, and the substantially circular core boundary of a HCPBF (see FIG. 1). Accordingly, antiresonant hollow core fibres can be described as negative curvature fibres. The kagome category of hollow core fibres can also be configured as negative curvature ARFs, and have a structured cladding of multiple small capillaries in an array, similar to HCPBF, but not configured to provide photonic bandgaps. In contrast to HCPBF, the guidance mechanism operates by antiresonance effects.

Herein, the terms hollow core optical fibre, hollow core fibre, hollow core waveguide, hollow core optical waveguide and similar terms are intended to cover optical waveguiding structures configured according to any of the above examples and similar structures, where light is guided by any of several guidance mechanisms (photonic bandgap guiding, antiresonance guiding, and/or inhibited coupling guiding) in a hollow elongate void or core surrounded by a structured cladding comprising a plurality of longitudinal capillaries. The capillaries comprise or define elongate holes, voids, lumina, cells or cavities which run continuously along the length or longitudinal extent of the optical fibre, substantially parallel to the elongate core which also extends continuously along the fibre's length. These various terms may be used interchangeably in the present disclosure.

The present disclosure relates to the use of hollow core optical fibres to implement optical fibre transmission links for carrying optical data, where a transmission link typically extends between a pair of datacentres, geographically located remote from one another.

FIG. 4 shows a simplified schematic representation (not to scale) of some parts of an example datacentre apparatus. The datacentre 100 houses a server 102 which generates and processes data to be transmitted from and received by the datacentre 100. The server 102 comprises a transceiver 116 configured to transmit outgoing data to another datacentre, and/or receive incoming data from the other datacentre, in optical form as optical signals. Also included in the datacentre 100 is a first optical patch panel 104 and a second optical patch panel 106, a patch panel being a hardware component with multiple ports to which optical cables can be connected for connecting and routing optical signals via the optical cables in a flexible manner. The datacentre 100 may additionally comprise other components (not shown) such as optical switches and multiplexers for connecting and routing optical signals via the optical cables. One or more optical fibre patch cords 108 connect the server 102, via the transceiver 116, with the first patch panel 104. One or more optical fibre intra-datacentre cables 110 connect the first patch panel 104 and the second patch panel 106. In the context of the current disclosure, the patch cord(s) 108 and the intra-datacentre cable(s) 110 comprise hollow core optical fibre. Note that the datacentre is given as an example only; optical transmission links described herein may also be used to carry optical signals between other formats of optical signal handling facilities which may be remotely located from one another.

The intra-datacentre cable(s) 110 may comprise several portions optically connected or joined in sequence such as by splices 112a, 112b. The portions may comprise a central portion 110a, a first end portion 110b between the first patch panel 104 and a first end of the central portion 110a, and a second end portion 110c between a second end of the central portion 110a and the second patch panel 106. The first and second end portions 110b, 110c may comprise optical waveguide adapter assemblies such as described in [3]. These adapter assemblies are components comprising a portion of solid core optical fibre, a portion of hollow core optical fibre, and a mode field adapter interposed between the solid core optical fibre and the hollow core optical fibre and configured to convert light propagating through it between a size of the optical mode field supported by the solid core optical fibre and a size of the optical mode field supported by the hollow core optical fibre. Typically, solid core optical fibre used for telecommunications may have a much smaller optical mode field than hollow core optical fibre, so that connecting the two fibre types directly can cause significant optical loss and may result in the propagating optical power coupling from the fundamental mode into higher order modes and back again, thereby creating multipath interference. The intervening mode field adapter provides a smooth transition between the differing optical mode field sizes, enabling the different fibres to be joined with reduced loss. Conventional optical patch panels are typically configured for connection with solid core optical fibres (since these are conventionally used for optical telecommunications links), and the optical waveguide adapter assemblies enable hollow core optical fibres to be connected to a standard patch panel via the portion of solid core fibre. This simplifies the use of hollow core optical fibres in telecommunications links by avoiding the requirement for patch panels and other components especially configured for direct connection with hollow core optical fibres. Although not shown, optical waveguide adapter assemblies may also be used to connect the hollow core optical fibre patch cord 108 to the transceiver 116 and the first patch panel 104.

An inter-datacentre cable 114 is connected to the second patch panel 106, and leads out of the datacentre 100 to carry outgoing optical signals to a second, remotely located, datacentre (not shown), and also to receive incoming optical signals from the second datacentre. The inter-datacentre cable 114 comprises hollow core optical fibre. The inter-datacentre cable 114 typically comprises a plurality of sequentially optically joined (such as by splices or connectors/couplers) portions of optical fibre. This is depicted simply in FIG. 4 as a central portion 114a of hollow core optical fibre, and an end portion 114b joined by a splice 112c. The end portion 114b may comprise an optical waveguide adapter assembly as described above with regard to the end portions 110 b, 110 c of the intra-datacentre 110.

In operation, the transceiver (or transmitter) 116 launches optical signals into the optical patch cord 108. The optical signals are transmitted through the optical patch cord 108, the first optical patch panel 104, the intra-datacentre cable 110, and the second patch panel 106, and into the inter-datacentre cable 114 which carries the optical signals out of the datacentre 100 to the second datacentre. For incoming optical signals from the second datacentre, the optical path is reversed (either along the same optical fibres, or along a parallel sequence of other optical fibres) to deliver the optical signals to the transceiver (or receiver) 116.

The various optical fibre portions may be considered as making up an optical fibre transmission link configured to propagate optical signals to and/or from the transceiver in the datacentre, and more broadly between the transceiver and a second transceiver in the second datacentre. The optical fibre transmission link therefore comprises various portions of hollow core optical fibre concatenated, or arranged sequentially, along the length of the link. As is clear from FIG. 3, various portions may be directly optically coupled to one another, or other elements (components such as patch panels, or portions of other optical fibre types such as solid core optical fibre, or optical elements such as mode field adapters and fibre connectors/couplers) may be interposed between portions of hollow core fibre. Other elements additional to or instead of the various elements shown in FIG. 3 may be incorporated in the optical fibre transmission link.

FIG. 5 shows a simplified schematic representation of an optical telecommunication system 120. The optical telecommunications system 120 comprises a first datacentre 100a and a second datacentre 110b. The datacentres 100a, 100b are shown in less detail than the datacentre 100 in FIG. 4, for simplicity. In particular, each datacentre 100a, 100b comprises a second patch panel 106a, 106b, but elements “behind” the second patch panels 106a, 106b are not shown. However, the datacentres 100a, 100b can be understood as comprising the same or similar elements as shown in FIG. 4. The second patch panels 106a, 106b are linked by an inter-datacentre cable 114 that extends between the first datacentre 100a and the second datacentre 100b. In this example, the inter-datacentre cable 114 comprises a several central portions 114a, 114c, 114d of hollow core optical fibre which are optically joined in sequence (concatenated) by splices 112d, 112e. This may be necessary to achieve the required total span of the optical fibre transmission link, as this may be greater than the individual fibre length that can be, or is desired to be, deployed (where length can be limited by factors such as cable installation methods or deliberate sectioning for servicing and maintenance). End portions 114b, 114e comprising for example optical waveguide adapter elements as described above, are coupled to the two ends of the joined hollow core fibre portions 114a, 114c, 114d by splices 112c, 112f in order to enable optical coupling of the hollow core fibre inter-datacentre cable 114 to the second patch panels 106a, 106b. More or fewer portions of hollow core fibre may be used to implement the inter-datacentre cable, however, and also the optical fibre transmission link in general. The invention is not limited in this regard.

From the foregoing description, it will be appreciated that an optical fibre transmission link comprises a number of concatenated portions of optical fibre, of which, in the context of the present disclosure, at least two comprise portions of hollow core optical fibre. The various portions can have different lengths according to their position and function in the optical fibre transmission link, which are typically in the following ranges:
End portions, being short portions used to connect longer length portions with components such as patch panels: a fraction of a metre to several metres, for example 0.2 metres to 10 metres.
Patch cord, being a cord connected between a transceiver and a patch panel: a fraction of a metre to tens of metres, for example 0.5 metres to 100 metres.
Intra-datacentre cable, being a cable connected between patch panels or other components within a datacentre or other facility: tens of metres to hundreds of metres, for example 50 metres to 1000 metres.
Inter-datacentre cable, being all or part of a cable connected between datacentres or other facilities: hundreds of metres to several or hundreds of kilometres, for example 500 metres to 100000 metres.

The present concept proposes to make use of these different lengths of fibre within an optical fibre transmission link to address the issue of multipath interference.

In order to achieve efficient propagation of optical signals, optical propagation loss or attenuation should be low for the fundamental optical mode. Conversely, attenuation is desirably high for higher order propagation modes in order to minimise multipath interference; if higher order modes are effectively attenuated they cannot produce significant interference. In hollow core optical fibres low fundamental mode loss and high higher order mode attenuation are therefore both desirable properties for optical signal propagation applications. Considerable progress has been made in achieving both characteristics, but there is a trade-off between the two because low fundamental mode loss tends to be associated with low higher order mode attenuation. Hence it is difficult to provide low fundamental mode loss and high higher order mode attenuation in the same hollow core optical fibre.

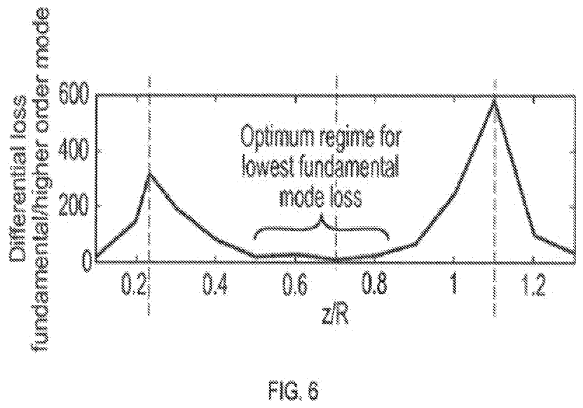

FIG. 6 (taken from FIG. 11 from [2]) shows a graph of the variation of differential loss (ratio of fundamental mode loss to higher order mode attenuation) with a parameter z/R which is a geometrical parameter describing the structural dimensions of an antiresonant hollow core optical fibre of the type shown in FIG. 3. This illustrates how the design of the fibre affects the different losses of interest, showing that low fundamental mode loss and high higher order mode attenuation cannot be achieved in a single design of hollow core optical fibre. It can be seen that the lowest fundamental mode loss occurs at intermediate geometrical values, for z/R in the range of 0.6 to 0.8, where the differential loss is low, while maximum higher order mode attenuation (differential loss is high and fundamental mode loss is not low) arises at more extreme geometries, for z/R in the ranges 0.2 to 0.3 and 1 to 1.2. Hence it is necessary to select between a hollow core fibre that has low fundamental mode loss, and a hollow core fibre that has a high higher order mode attenuation. This is true for hollow core fibres in general. The loss and attenuation characteristics (and other optical properties) of a hollow core fibre can be tailored by appropriate selection of the sizes, shapes, positions and quantities of the various tubes making up the cladding and defining the hollow core space; this applies to both antiresonant and photonic bandgap fibre types. Thus, a fibre having a required value for loss/attenuation can be selected. Loss/attenuation of an optical fibre varies with wavelength, so this should be taken into account when selecting an optical fibre; for a given application a particular wavelength or wavelength range may be specified so the selected fibre should have the required value of loss/attenuation at that wavelength or wavelength range. In an optical fibre transmission link, this will be the wavelength or range of wavelengths of optical signals to be propagated.

Consider this in the present context of an optical fibre transmission link comprising portions of hollow core optical fibre. As an example, for shorter portions of optical fibre, such as the end portions and the patch cords, the selection of a hollow core fibre that has sufficiently high higher order mode attenuation that multipath interference is suppressed to a satisfactory level will at the same time degrade the overall optical loss of the transmission link because the fundamental mode loss will also be high in these portions. On the other hand, selection of a hollow core fibre with low fundamental mode loss for the purpose of minimising the overall optical loss of the transmission link will at the same time allow multipath interference to flourish because attenuation of the higher order modes is low. The performance of the optical fibre transmission link is degraded either by high fundamental mode loss, or significant multipath interference.

The concept of the present disclosure proposes to balance these factors in order to provide an optical fibre transmission link in which the effect of multipath interference is mitigated while overall optical loss is maintained low. This is achieved by using hollow core fibres with different loss/attenuation values for different lengths of the fibre portions within the link, which also allows excessive lengths of the optical fibre to be avoided thereby also avoiding increased latency and cost.

Overall, an acceptable optical fibre transmission link performance (in terms of low loss and low multipath interference) is offered by selecting hollow core fibres with different combinations of fundamental mode loss and higher order mode attenuation for different portions of a link. In particular, for shorter portions of optical fibre, such as the end portions and patch cables, a hollow core optical fibre with a relatively high higher order mode attenuation (and inevitable accompanying relatively high fundamental mode loss) is selected. The high higher order mode attenuation suppresses any higher order modes and ensures that multipath interference is mitigated, while the short length means that the high fundamental mode loss of the portion of optical fibre does not contribute significantly to the overall loss of the transmission link. Conversely, for longer portions of optical fibre, such as portions making up the inter-datacentre cable (of which two or more may be spliced together to achieve the required span for the transmission link), a hollow core fibre with relatively low fundamental mode loss (and inevitable low higher order mode attenuation) can be selected. The low fundamental mode loss of these portions keeps the overall loss of the transmission link low, while the low higher order mode attenuation is offset by the long lengths of the portions so that total loss for the higher order modes is large enough that higher order modes are suppressed and a low multipath interference is maintained. In addition, any fibre portions of intermediate length (between the lengths of the shorter portions and the longer portions), such as intra-datacentre cables connecting patch panels, can be selected to have a different balance again of fundamental mode loss and higher order mode attenuation, such as intermediate between the high higher order mode loss of the shorter fibre portions and the low higher order mode loss of the longer fibre portions.

One way of implementing an optical fibre transmission link comprising portions of hollow core optical fibres with different balances between fundamental mode loss and higher order mode attenuation is to determine a suitable balance for each portion of the link, with reference to the length of each portion, and thereby specify an individual balance of loss/attenuation for every portion of the transmission link and select multiple different designs of hollow core optical fibre accordingly. In practice, however, this is a very cumbersome process and will tend to be costly since it requires detailed coordination along a chain of supply and fabrication, from a system designer of the transmission link to one or more manufacturers of hollow core optical fibres.

Accordingly, a simpler and more realistic approach is also proposed. Providers of shorter optical fibre transmission link components such as optical waveguide adapter assemblies and patch cords may adopt hollow core optical fibres with relatively high higher order mode attenuation (and therefore also high fundamental mode loss). Providers of longer optical fibre transmission link components such as inter-datacentre cables may adopt hollow core optical fibres with relatively low higher order mode attenuation (and therefore also low fundamental mode loss). Providers of intermediate length optical fibre transmission link components such as intra-datacentre cables may adopt hollow core optical fibres with intermediate higher order mode attenuation and fundamental loss. This allows the system designer to assemble an optical fibre transmission link directly from standard off-the-shelf components.

In summary, an optical fibre transmission link is proposed which is made up of portions of optical fibre concatenated to define a total length for the link, the portions including at least one short portion of hollow core optical fibre and at least one long portion of optical fibre. The short portion has a length of about 100 m or less and a first value of higher order mode attenuation. The long portion has a length of about 500 m or more, and a second value of higher order mode attenuation which is smaller that the first value of higher order mode attenuation. The values of the higher order mode attenuation are specified at the wavelength or wavelength range of the optical signals to be propagated by the optical fibre transmission link. In other words, when assembling an optical fibre transmission link, a plurality of portions of hollow core optical fibre may be selected, with the shorter portions have a relatively high higher order mode attenuation and the longer portions having a relatively low higher order mode attenuation. For simplicity, all the shorter portions (all portions less than about 100 m in length) may have the same value of higher order mode attenuation, and all the longer portions (all portions more than about 500 m in length) may have the same, lower or smaller, value of higher order mode attenuation. This is not essential, however, and more generally, if there are two or more shorter portions and two or more longer portions, each of the shorter portions has a value of higher order mode attenuation which is larger or greater than the largest value of higher order mode attenuation of each of the longer portions. Further, since a larger value of higher order mode attenuation is associated with a larger value of optical loss at the fundamental mode, the short portion or portions may have a value of fundamental mode loss at the wavelength or wavelengths of the optical signals which is larger than the value of fundamental mode of loss of the longer portion or portions.

In addition, the optical fibre transmission link may include one or more intermediate portions of hollow core optical fibre. By “intermediate” it is meant that the length or lengths of the intermediate portions are intermediate between the length(s) of the short portions and the lengths of the long portions This can be considered numerically, so that the at least one intermediate portion has a length in the range of about 100 m to about 500 m. Alternatively, it can be considered relatively, such that the intermediate portion or portions have/has a length which is longer than the or each short portion, all of which are not longer than 100 m, and which is shorter than the or each long portion, all of which are not shorter than 500 m. The one or more intermediate portions each have a higher order mode attenuation which is larger than that of the long portion or portions and smaller than that of the short portion or portions, in other words, the higher order mode attenuation has an intermediate value.

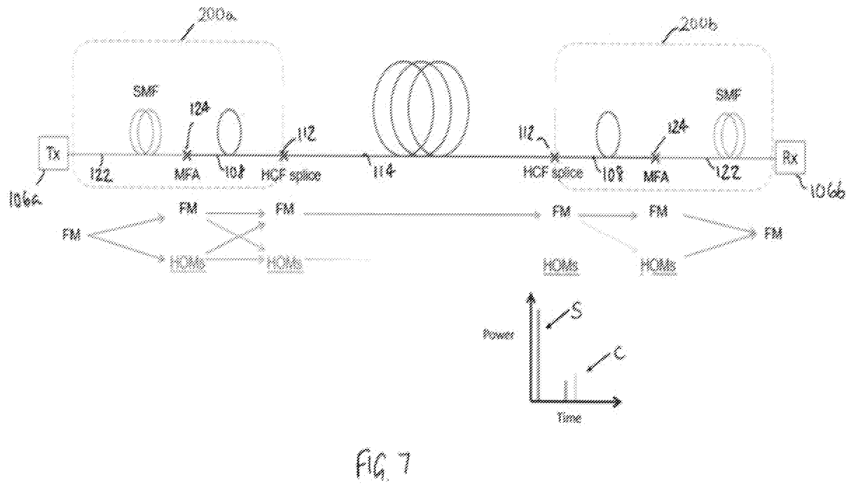

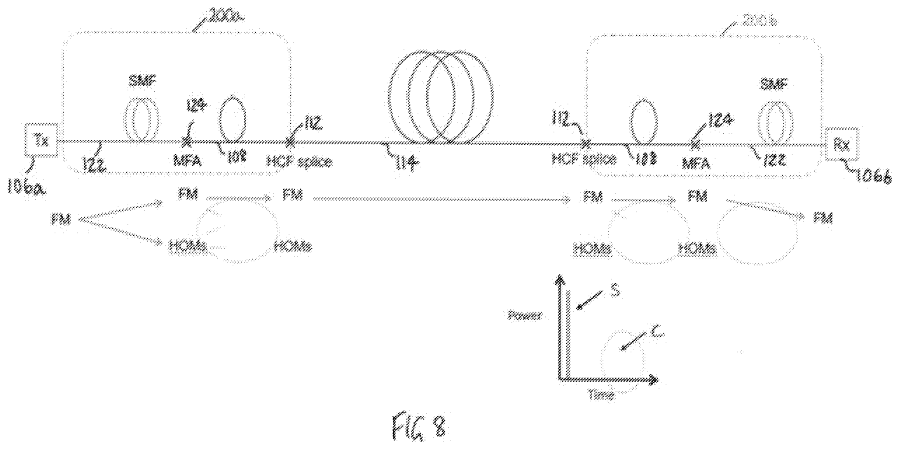

FIG. 7 shows a highly schematic and simplified representation of another example of an optical telecommunications system, with reference to which the proposed concept can be further described. In this example, the system again comprises a pair of transceivers at two remotely located datacentres or other facilities connected by an optical fibre transmission link. In this example, the transceivers comprise a transmitter 106a at a first datacentre or facility and a receiver 106b at a second datacentre or facility. At the first datacentre, a first optical waveguide adapter assembly 200a is interposed between the transceiver 106a and a long portion 114 of hollow core optical fibre comprised in an inter-datacentre cable. The first optical waveguide adapter assembly 200a comprises a portion of single mode (solid core) optical fibre 122 connected at its proximal end to the transmitter 106a, and a mode field adapter 124 which is used to provide low loss optical coupling from the distal end of the single mode optical fibre 122 into a proximal end of a short portion 108 of hollow core optical fibre. The distal end of the short portion 108, being the output of the first optical waveguide adapter assembly, is spliced via a hollow core fibre splice 112 to the proximal end of the long portion 114 of hollow core optical fibre. The inter-datacentre cable comprising the long portion 114 of hollow core optical fibre extends from the first datacentre to the second data centre, where its distal end is spliced at a hollow core fibre splice 112 to the input of a second optical waveguide adapter assembly 200b. The second optical waveguide adapter assembly 200b mirrors the first optical waveguide adapter assembly 200a. Hence, the splice 112 is at the proximal end of a second short portion 108 of hollow core optical fibre, which is coupled at its distal end via another mode field adapter 124 to another portion of single mode (solid core) optical fibre 122, which is connected to the receiver 106b. In this example, the three portions of hollow core optical fibre all have the same or a similar value of higher order mode attenuation and fundamental mode loss, which are selected to be relatively low in order to provide a lower overall propagation loss for the whole optical fibre transmission link.

Below the representation of the optical telecommunications system, FIG. 7 shows a depiction of the evolution of an optical signal propagated through the optical fibre transmission link. Beginning at the left side of the drawing, an optical signal is launched from the transmitter 106a into the fundamental mode FM of the single mode optical fibre 122. At the first MFA 124 most of the power in the FM of the single mode optical fibre 122 is launched into the FM of the hollow core optical fibre 108 while a part of the power in the FM of the single mode optical fibre 122 is transferred into the HOMs of the hollow core fibre 108, so that after the mode field adapter 124 both the FM and HOMs are present. These multiple modes propagate along the first short portion of hollow core fibre 108. The parts(s) of the optical signal which have propagated in the HOMs will be delayed with respect to the part which has propagated in the FM. Because this portion 108 of hollow core fibre is both short and has a low higher order mode attenuation, the HOMs do not decay significantly and are still present at the first hollow core splice 112. The splice 112 allows power to couple into both the FM and the HOMs of the long portion 114 of hollow core optical fibre from both the FM and the HOMs of the short portion of hollow core optical fibre 108, resulting in the signal and a delayed replica of the signal propagating in the FM of the long portion 114. However, because the long portion 114 has a significant length, there is sufficient distance for the HOMs to decay despite the relatively low value of the higher order mode attenuation. At the distal end of the long portion 114, the HOMs have largely or completely been suppressed, and most or all of the remaining optical power is in the FM of the long portion 114. However, the splice 112 at the distal end of the long portion 114 causes energy to be coupled from the FM into HOMs of the second short portion 108 of hollow core fibre. Owing to the short length of the second short portion 108, the HOMs are not wholly suppressed by the higher order mode attenuation and are still present at the distal end of the short portion 108. The second mode field adapter 124 then combines the power in the various modes into the FM of the second single mode fibre 122, which delivers the optical signal to the receiver 106b. However, the part(s) or portion(s) of the optical signal which have propagated in the HOMs have traversed a longer optical path and are delayed at the receiver 106b compared to the portion of the optical signal propagated in the FM. This is depicted in the graph of optical power against time at the lower right of FIG. 7, which shows the relatively high power optical signal S arriving earlier in time, followed by lower power delayed copies C of the signal originating from the HOMs. These copies C interfere with the signal S, producing undesirable multipath interference at the receiver 106b which increases the signal-to-noise ratio of the delivered optical data.

FIG. 8 shows the optical telecommunication system of FIG. 7 modified in accordance with the present disclosure. The system comprises the same components as the FIG. 7 example, with the difference that the various portions of hollow core optical fibre have different values of higher order mode attenuation. The two shorter portions 108 of hollow core fibre have a relatively larger higher order mode attenuation, which is larger than the relatively small higher order mode attenuation of the longer portion 114 of hollow core optical fibre, which may be the small value used for all the hollow core fibre portions in the FIG. 7 arrangement.

The evolution of the propagating optical signal is shown below the system, as before. Again, at the first MFA 124 most of the power in the FM of the single mode optical fibre 122 is launched into the FM of the short portion 108 of hollow core fibre while a part of the power in the FM of the single mode optical fibre 122 is transferred into the HOMs of the short portion 108 of hollow core fibre 108. However, owing to the large higher order mode attenuation of the short portion 108, the HOMs have decayed by the time the optical signal reaches the splice 122 with the longer portion 114 of hollow core optical fibre, and the optical signal enters the longer portion 114 in the FM only. Owing to the small higher order mode attenuation, and corresponding small fundamental mode loss, the bulk of the optical power carried in the FM is still present at the distal end of the longer portion 114. The splice 112 causes some transfer of power into HOMs of the second short portion 108 of hollow core fibre, but as at the other end of the optical fibre transmission link, the large higher order mode attenuation suppresses the HOMs by the time the optical signal reaches the second mode field adapter 124, and the optical signal is transferred into the second single mode fibre 122 for delivery to the receiver 106b in the FM only. The ovals in the depiction of the optical signal indicate the suppression and absence of the HOMs where these were present in the FIG. 7 system. Similarly, a graph of optical power against time is included at the bottom right of FIG. 8, and shows the large amount of power in the optical signal S, and the absence of any lower power delayed copies of the signal C. Hence there is little or no multipath interference at the receiver 106b, and the quality of the received optical signal is enhanced.

The various examples of optical fibre transmission links described above are illustrative only, and a link in accordance with the proposed concept may comprise more or fewer portions of optical fibre and more or fewer or other components, joints, splices, couplers and the like between portions of optical fibre. As a minimum, however, the link comprises at least one short portion of hollow core fibre and at least one long portion of hollow core fibre with higher order mode attenuation values as described, in other words, the long portion has a smaller higher order mode attenuation than the short portion.

The actual higher order mode attenuations may have any values that meet this criterion, and can be selected according to various requirements. These include factors such as the availability or not of standard or commercial hollow core fibres and fibre components (pre-assembled cables, patch cords and mode field adapters and the like) versus the ability to fabricate bespoke hollow core fibres with a precise attenuation/loss characteristic, and the length of the portions (so that higher order modes can decay as much as possible over a short portion, and the fundamental mode power is preserved as much as possible over long portions, for example).

However, merely as examples, considering a typical optical fibre communications link, typical lengths of fibre components, and the likely maximum length of long portions of hollow core optical fibres (which may be limited by manufacturing capability for these complex fibre structures), the larger higher order mode attenuation for the short hollow core fibre portions may have a value of 10 dB/m or more, and the smaller higher order mode attenuation for the long hollow core fibre portions may have a value of 1 dB/m or less. Intermediate values for any intermediate length hollow core fibre portions may be in the range of 1 dB/m to 10 dB/m. Likewise, the larger fundamental mode loss or attenuation for the short hollow core fibre portions may have a value of 20 dB/km or more, and the smaller fundamental mode loss or attenuation of the long hollow core fibre portions may have a value of 0.5 dB/km or less. Intermediate values for any intermediate length hollow core fibre portions may be in the range of 1 dB/km to 10 dB/km.

Note that where more than one short portion, more than one long portion, or more than one intermediate portion are used, these portions may have different attenuation values and different lengths within the ranges indicated for the various portion sizes. Conveniently, however, the same or similar values may be selected for all short portions and/or for all long portions. Also, the various values are examples only, and the larger or smaller values of attenuation may be used that satisfy the criterion of short portions having a larger higher order mode attenuation than long portions.

More generally, the greater higher order mode attenuation of the short portion(s) of hollow core optical fibre can be considered in terms of the amount by which the higher order mode attenuation of the long portion(s) is exceeded. This amount may be selected according to the relative and overall lengths of the various portions, and the attenuation values of hollow core fibres which are practically available, in order to achieve the desired suppression of multipath interference. Usefully, for example, the higher order mode attenuation of the short portion(s) may be at least 5 dB/m greater than the higher order mode attenuation of the long portion(s). In some cases a larger difference may be appropriate, for example the short portion higher order mode attenuation may be at least 10 dB/m greater than the long portion value. In other cases, a smaller difference be sufficient to provide a desirable level of suppression, so that the short portion higher order mode attenuation may exceed that of the long portion(s) by only 1 dB/m or 2 dB/m.

When selecting the hollow core fibres, it is useful, particularly when the fibres are to be spliced together, for as many other properties and characteristics of the fibres to be matched or have minimal variation between the fibre portions, in order to minimise optical loss across splices and joins in the optical fibre transmission link. Relevant properties include core diameter, cladding diameter, mode field diameter, and order of symmetry of the structured cladding. While desirable, this matching is not essential, and may in some cases be precluded by availability of hollow core optical fibre with the required higher order mode attenuation.

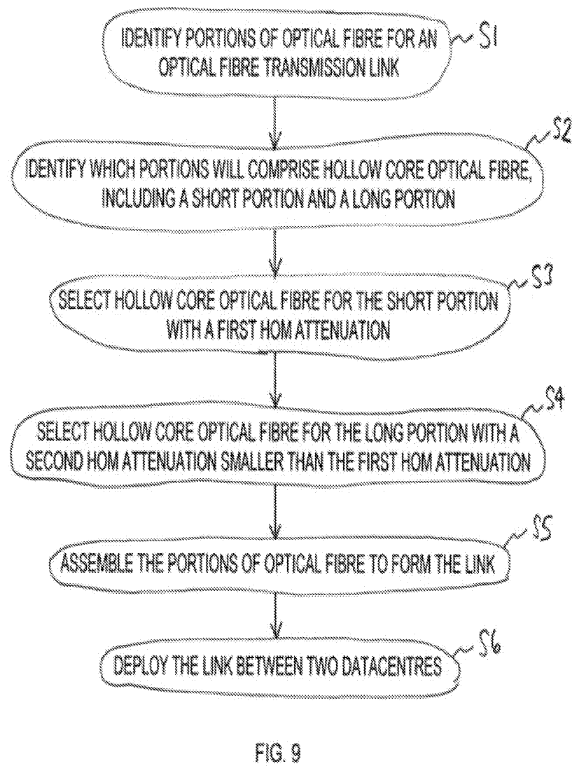

FIG. 9 shows a flow chart of steps in an example method according to the present disclosure, the method being for producing an optical fibre transmission link. In a first step S1, a plurality of portions of optical fibre for defining an optical fibre transmission link are identified. The portions are to be arranged sequentially to form the link, possibly with intervening optical components and elements as described above. In a second step S2, portions of the optical fibre which are to be implemented using hollow core optical fibre are identified out of the plurality of portions. These hollow core optical fibre portions include at least one short portion (having a length of about 100 m or less as discussed above), and at least one long portion (having a length of about 500 m or more, also as discussed above). In a third step S3, hollow core fibre for the short portion is selected (from available hollow core fibres and hollow core fibre components, or to be specially fabricated) which has a first, relatively high, higher order mode attenuation at a wavelength or wavelengths for which the optical fibre transmission link is intended to operate. Then, in a fourth step S4, hollow core fibre for the long portion is selected, having a second, relatively low, higher order mode attenuation at the wavelength or wavelengths, the second higher order mode attenuation being smaller than the first higher order mode attenuation.

These first four steps might be considered as a configuration process, in which the optical fibre components required for an optical fibre transmission link are selected and gathered. At some later time, the method may proceed to a fifth step S5, in which the identified portions of optical fibre from steps S2-S4, plus any intervening optical components, are assembled by being optically coupled or optically connected together to form the optical fibre transmission link. Finally, in step S6, the optical fibre transmission link is deployed for operation, such as between a pair of optical transceivers located at two remotely spaced datacentres or other optical signal handling facilities. The assembly step and the deployment step may be carried out partially or wholly together if the optical fibre portions are joined together in situ at the datacentres.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in the future.

1. An optical fibre transmission link for propagating optical signals at a selected wavelength or wavelength range to and/or from an optical transceiver, the optical fibre transmission link comprising:
portions of optical fibre arranged sequentially along a length of the optical fibre transmission link, the portions of optical fibre comprising at least two portions of hollow core optical fibre, the at least two portions of hollow core optical fibre including at least one short portion of hollow core optical fibre having a length of 100 m or less and at least one long portion of hollow core optical fibre having a length of 500 m or more;
wherein the at least one short portion has a higher order mode attenuation at the wavelength or wavelength range which is greater than a higher order mode attenuation at the wavelength or wavelength range of the at least one long portion.

2. An optical fibre transmission link according to claim 1, wherein the at least one long portion comprises a plurality of long portions, each long portion having a higher order mode attenuation at the wavelength of wavelength range which is smaller than the higher order mode attenuation at the wavelength or wavelength range of the at least one short portion.

3. An optical fibre transmission link according to claim 2, wherein each long portion has substantially the same higher order mode attenuation at the wavelength or wavelength range.

4. An optical fibre transmission link according to claim 1, wherein the at least one short portion comprises a plurality of short portions, each short portion having a higher order mode attenuation at the wavelength or wavelength range which is greater than the higher order mode attenuation at the wavelength or wavelength range of the at least one long portion.

5. An optical fibre transmission link according to claim 4, wherein each short portion has substantially the same higher order mode attenuation at the wavelength or wavelength range.

6. An optical fibre transmission link according to claim 1, wherein the at least one short portion has a propagation loss for a fundamental mode at the wavelength or wavelength or wavelength range which is greater than a propagation loss for a fundamental mode at the wavelength or wavelength range of the at least one long portion.

7. An optical fibre transmission link according to claim 1, wherein the higher order mode attenuation at the wavelength or wavelength range of the at least one short portion is at least 5 dB/m greater than the higher order mode attenuation at the wavelength or wavelength range of the at least one long portion.

8. An optical fibre transmission link according to claim 1, wherein the higher order mode attenuation at the wavelength or wavelength range of the at least one short portion is 10 dB/m or above, and the higher order mode attenuation at the wavelength or wavelength range of the at least one long portion is 1 dB/m or below.

9. An optical fibre transmission link according to claim 1, wherein the plurality of portions of hollow core optical fibre further includes at least one intermediate portion of hollow core fibre having a length which is longer than the at least one short portion and shorter than the at least one long portion, and wherein the at least one intermediate portion has a higher order mode attenuation at the wavelength or wavelength range which is greater than the higher order mode attenuation at the wavelength or wavelength range of the at least one long portion and smaller than the higher order mode attenuation at the wavelength or wavelength range of the at least one short portion.

10. An optical fibre transmission link according to claim 9, wherein higher order mode attenuation at the wavelength or wavelength range of the at least one intermediate portion is in the range of 1 dB/m to 10 dB/m, the higher order mode attenuation at the wavelength or wavelength range of the at least one short portion is greater than 10 dB/m, and the higher order mode attenuation at the wavelength or wavelength range of the at least one long portion is less than 1 dB/m.

11. An optical fibre transmission link according to claim 1, wherein the at least one short portion and the at least one long portion have a core diameter and/or a cladding diameter and/or a mode field diameter and/or an order of symmetry of the structured claddding which are matched to one another.

12. An optical fibre transmission link according to claim 1, wherein the at least one short portion and/or the at least one long portion are comprised within an optical fibre cable.

13. An optical fibre transmission link according to claim 1, wherein the at least one short portion is comprised in a patch cord or an optical waveguide adapter assembly for mode field adaptation.

14. An optical fibre transmission link according to claim 1, wherein the at least one long portion comprises one or more long portions optically coupled consecutively to define a propagation path for optical signals between the optical transceiver, being located in a first optical signal handling facility, and a second optical transceiver located in a second optical signal handling facility remote from the first optical signal handling facility.

15. An optical fibre transmission link according to claim 1, wherein the at least one long portion is comprised in an optical fibre cable for propagating optical signals between remotely located optical signal handling facilities.

16. An optical fibre telecommunications system comprising a first optical transceiver and a second optical transceiver for transmitting and/or receiving optical signals, and an optical fibre transmission link according to claim 1 arranged to propagate optical signals between the first optical transceiver and the second optical transceiver.

17. An optical fibre telecommunications system according to claim 16, wherein the first optical transceiver is located at a first optical signal handling facility and the second optical transceiver is located at a second optical signal handling facility remote from the first optical signal handling facility.

18. An optical fibre telecommunications system according to claim 17, wherein the first optical signal handling facility and the second optical signal handling facility are a first datacentre and a second datacentre.

19. A method for producing an optical fibre transmission link comprising:
identifying (S1) a plurality of portions of optical fibre to be arranged sequentially to define an optical fibre transmission link for propagating optical signals at a selected wavelength or wavelength range to and/or from an optical transceiver;
from the plurality of portions of optical fibre, identifying (S2) at least two portions to comprise portions of hollow core optical fibre, the at least two portions including at least one short portion of hollow core optical fibre having a length of 100 m or less and at least one long portion of hollow core optical fibre having a length of 500 m or more;
selecting (S3), for the at least one short portion, a hollow core optical fibre with a first higher order mode attenuation at the wavelength or wavelengths; and
selecting (S4), for the least one long portion, a hollow core optical fibre with a second higher order mode attenuation at the wavelength or wavelengths which is smaller than the first higher order mode attenuation.

20. A method according to claim 19, further comprising optically connecting the plurality of portions of optical fibre to form the optical fibre transmission link.
